(19) United States
(12) Patent Application Publication
(10) Pub. No.: US 2016/0049892 A1
(43) Pub. Date: Feb. 18, 2016

(54) Systems and Methods for Variable Speed Drives

(71) Applicant: Baker Hughes Incorporated, Houston, TX (US)

(72) Inventors: Amin A. Moghadas, Houston, TX (US); Evan G. Mackay, Claremore, OK (US); John M. Leuthen, Claremore, OK (US); Renato L. Pichilingue, Houston, TX (US)

(21) Appl. No.: 14/462,384

(22) Filed: Aug. 18, 2014

(51) Int. Cl. H02P 23/00; H02P 21/00; E21B 43/12; H02P 6/14

(52) U.S. Cl. CPC H02P 23/0081; H02P 6/14; H02P 21/0035; E21B 43/128

(57) ABSTRACT

Systems and methods for driving downhole equipment using a variable speed drive that has a switching mechanism between a first, constant-voltage capacitor bank and a second capacitor bank to control the voltage on the second capacitor bank, thereby enabling generation of a six-step output waveform while maintaining low input harmonics. In one embodiment, a variable speed drive has a converter section, an inverter section, two capacitor banks and a chopper. The converter section is controlled by a controller to convert AC power to DC power and charges the first capacitor bank to a substantially constant voltage. A chopper selectively couples the first capacitor bank to the second capacitor bank and thereby controls the voltage on the second capacitor bank. The inverter section can then produce a six-step output waveform at the voltage of the second capacitor bank. The variable speed drive can operate alternately in a pulse width modulation mode.

### BACKGROUND

1. Field of the Invention

The invention relates generally to electrical control systems, and more particularly to systems and methods for providing electrical power to downhole oil production equipment such as electrical submersible pumps.

2. Related Art

Electric submersible pumps are commonly used to pump fluids (e.g., crude oil) out of wells that may be thousands of feet deep. These pumps are driven by power systems that are at the surface of the wells and are connected to the pumps by thousands of feet of electrical cable. The power systems may, for example, include variable speed drives that can control the speed of the pump motors and thereby control the speed at which the oil is pumped out of the wells.

A variable speed drive normally receives low-to-medium-voltage AC power, converts the AC power to DC which charges a capacitor bank, and then draws energy from the capacitor bank to produce AC output power at a desired voltage and frequency that is supplied to the pump motor. The supplied AC output power is ideally sinusoidal, because motors have less losses in true sinusoidal waveforms. The desired sinusoidal output is commonly approximated by either a pulse width modulation waveform, or a six-step waveform. If it is desired to produce a pulse width modulation waveform, the variable speed drive will normally maintain a constant voltage on the capacitor bank and output varying-width pulses of constant voltage. If it is desired to produce a six-step waveform, the variable speed drive will produce a variable voltage on the capacitor bank and output equal-width pulses at stepped voltages.

### SUMMARY OF THE INVENTION

This disclosure is directed to systems and methods for providing electrical power and to downhole oil production equipment such as electrical submersible pumps, wherein a variable speed drive uses a switching mechanism between a first, constant-voltage capacitor bank and a second capacitor bank in order to control the voltage on the second capacitor bank and thereby enable generation of a six-step output waveform while maintaining low input harmonics and a unity power factor.

In one particular embodiment, a variable speed drive has a converter section, an inverter section, two capacitor banks and a chopper. The converter section is configured to convert received AC power to DC power. A first one of the capacitor banks is coupled to the converter section, and the DC power produced by the converter section charges the first capacitor bank to a first, substantially constant voltage which is determined by the controller that controls the converter section. The second capacitor bank is coupled to the first capacitor bank through a chopper which selectively enables DC power from the first capacitor bank to charge the second capacitor bank. The inverter section is coupled to the second capacitor bank and is configured to invert DC power from the second capacitor bank to produce an AC output waveform.

In one embodiment, the chopper consists of a switch that can be switched on to connect the two capacitor banks, or switched off to disconnect the capacitor banks from each other. In a six-step mode of operation, the chopper is switched on and off with a duty cycle of up to 100%, so that the second capacitor bank is charged to a voltage that may be less than the voltage on the first capacitor bank. The voltage on the second capacitor bank is determined primarily by the duty cycle of the chopper and the voltage on the first capacitor bank The voltage on the second capacitor bank controls the amplitude of the six-step output waveform produced by the inverter section. In a pulse width modulation mode, the chopper remains switched on, so that the second capacitor bank is charged to the same voltage as the first capacitor bank. The effective amplitude of the pulse width modulated output waveform is controlled by the widths of the output pulses. The converter section, chopper and inverter section may all be controlled by a single controller in the variable speed drive. The variable speed drive may employ space vector modulation (SVM) or other methodologies to reduce the input harmonics or to achieve unity power factor in the variable speed drive.

An alternative embodiment comprises an artificial lift system that includes a variable speed drive as described above coupled to an electric submersible pump. The variable speed drive may be configured to initially operate in a pulse width modulation mode in which the pulse width modulated output waveform of the variable speed drive is filtered before being provided to the electric submersible pump. Usually, an LC filter is used as a low pass filter to filter high frequency signals and thereby generate a less noisy sinusoidal output. If the filters fail, the variable speed drive can be switched to a six-step mode in which the chopper operates to control the voltage on the second capacitor bank and the inverter section produces a six-step output waveform instead of a pulse width modulated waveform.

Another alternative embodiment comprises a method for producing an output waveform suitable for driving downhole equipment such as an electric submersible pump. In this method, a variable speed drive similar to that described is provided. AC power is received at a converter section of the variable speed drive from an external AC power source that is connected to the converter section. The converter section converts the AC power to DC power and charges a first capacitor bank to a substantially constant first DC voltage. In a six-step mode, a chopper coupled between the first capacitor bank and a second capacitor bank is alternately switched on and off, charging the second capacitor bank to a desired voltage. The chopper is operable with a duty cycle of less than or equal to 100%, so the second capacitor bank is chargeable to a second voltage that is less than or equal to the first voltage. The voltage on the second capacitor bank is then used by the inverter section to produce a six-step output waveform. The variable speed drive may also be operated in a pulse width modulation mode in which the chopper remains switched on to allow the second capacitor bank to be charged to the same voltage as the first capacitor bank. The inverter section then produces a pulse width modulated output waveform using the voltage on the second capacitor bank.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a functional block diagram illustrating the structure of a typical pump system in accordance with the prior art.

FIG. 2 is a functional block diagram illustrating the structure of a variable speed drive in accordance with one embodiment.

FIG. 3 is a more detailed diagram illustrating the structure of a variable speed drive in one embodiment.

FIG. 4 is a flow diagram illustrating a method in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for providing electrical power and to downhole equipment such as electrical submersible pumps using a variable speed drive, wherein the variable speed drive includes two capacitor banks that are coupled to each other by a chopper that enables the voltage on one of the capacitor banks to be controlled while the other is maintained at a substantially constant voltage.

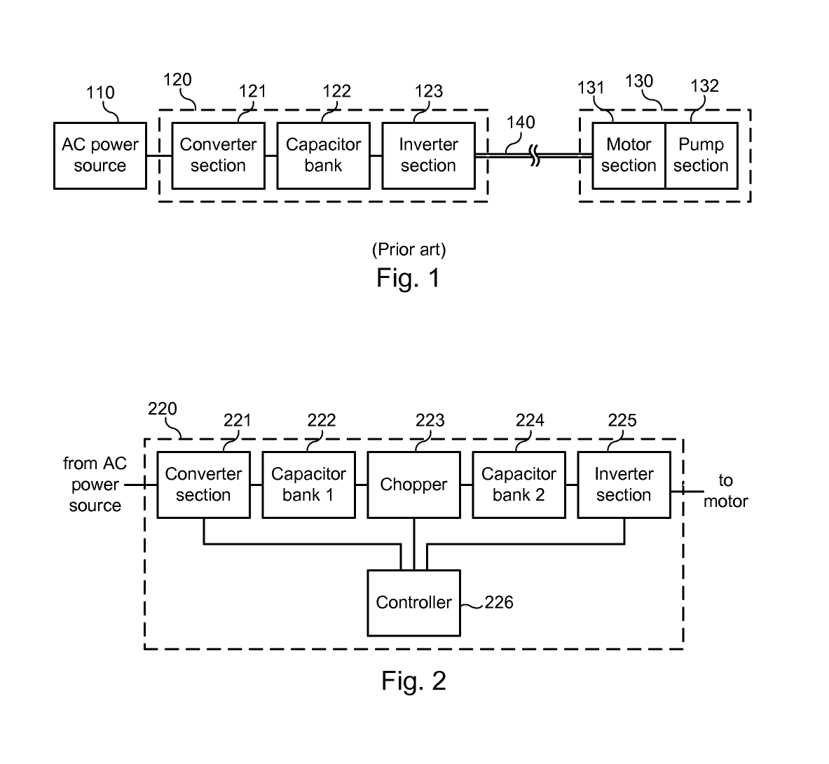

Referring to FIG. 1, a functional block diagram illustrating the structure of a prior art artificial lift system used in an oil well is shown. The system includes an AC power source 110, a variable speed drive 120 and a electric submersible pump 130. AC power source 110 may, for example, be a three-phase, 50-60 Hz, 400V-480V power source. The three-phase power from source 110 is provided to the converter section 121 of variable speed drive 120. Converter section 121 converts the AC power to DC, and the output of the converter section charges a capacitor bank 122. Capacitor bank 122 provides DC power to an inverter section 123 of the drive. Inverter section 123 draws energy from the capacitor bank and produces an output voltage which is used to drive electric submersible pump 130. The output voltage of variable speed drive 120 is transmitted to pump 130 via cable 140 and is used to power the motor section 131 of the pump. Motor section 131 then drives pump section 132 to pump fluid out of the well.

As indicated above, conventional variable speed drives for equipment such as electric submersible pumps are not able to provide low input harmonics, a unity power factor, and a six-step waveform. The variable speed drives disclosed herein are configured to produce either a six-step waveform or PWM waveform, and the drives have low input harmonics and a unity power factor when producing either of these output waveforms.

The present systems and methods therefore implement the drive with boost inductors for each phase, and two separate capacitor banks that have a chopper coupled between them. The chopper is a switch that is configured to alternately connect and disconnect the capacitor banks. This allows the converter section to operate in a manner that charges the first capacitor bank to a constant voltage and produces low input harmonics, while the second capacitor bank is charged to a variable voltage that facilitates generation of a six-step output waveform.

Referring to FIG. 2, a functional block diagram of a drive in accordance with one embodiment is shown. The drive may, for instance, be a variable speed drive that is suitable for providing power to downhole equipment such as electric submersible pump systems.

As depicted in FIG. 2, drive 220 includes a converter section 221, a first capacitor bank 222, a chopper 223, a second capacitor bank 224, an inverter section 225, and a controller 226. Converter section 221 receives AC input power from a source such as an external power grid through the boost a set of boost inductors. Converter section 221 rectifies the AC power and uses the rectified power to charge first capacitor bank 222. The boost inductors allow the converter section to charge the first capacitor to a voltage which is higher than the peak phase-to-phase voltage of the external AC power source. Converter section 221 is controlled by controller 226, which uses a third-harmonic injection method to reduce the input harmonics of drive 220. Other methodologies may also be implemented in the controller to achieve reduction of input harmonics, reactive power compensation, unity power factor, and the like.

Converter 221 charges first capacitor bank 222 to a constant voltage. (“Constant” is used here to refer to a voltage that is substantially the same over time, but may have relatively minor variations resulting from the rectification process or recharging of the second capacitor bank, or more substantial, but less frequent interruptions in the external power.) Chopper 223 is controlled to selectively connect or disconnect first capacitor bank 222 to second capacitor bank 224. In this manner, chopper 223 controls the charging of second capacitor bank 224, and consequently controls the voltage on the second capacitor bank. Chopper 223 is controlled in this embodiment by controller 226.

Second capacitor bank 224 is coupled to inverter section 225. Inverter section 225 inverts the DC power on second capacitor bank 224 to produce an output waveform that approximates or simulates a sine wave. In one embodiment, inverter section 225 is configured to operate in either a six-step mode or a pulse width modulation mode. In an alternative embodiment, inverter section may be configured to operate only in the six-step mode. Inverter section 225 is controlled by controller 226.

As noted above, when it is desired to produce a six-step output waveform, the voltage on second capacitor bank 224 is varied. This is accomplished by controlling the amount of current that flows through chopper 223. In one embodiment, chopper 223 is simply a switch that is turned on and off. When the switch is turned on, second capacitor bank 224 is connected to first capacitor bank 222, and current flows through the chopper to recharge the second capacitor bank. When the switch is turned off, second capacitor bank 224 is disconnected from first capacitor bank 222, so no current is allowed to flow through the chopper. Consequently, when the energy from second capacitor bank 224 is used by inverter section 225 to produce an output waveform, the voltage on the second capacitor bank may drop.

The voltage on second capacitor bank 224 can therefore be controlled by controlling the amount of time chopper 223 is switched on. In one embodiment, chopper 223 is switched on and off at frequent intervals. Chopper 223 is switched on for a first portion of each period and switched off for the remainder of the period. The duty cycle of chopper 223 (the percentage of the period during which the chopper is switched on) roughly controls the flow of energy into second capacitor bank 224, and therefore the voltage on the second capacitor bank. In other words, the higher the duty cycle, the higher the voltage, and the lower the duty cycle, the lower the voltage. When the chopper is operated with a 50% duty cycle, the voltage on the second capacitor bank will be approximately half of the voltage on the first capacitor bank.

When drive 220 is operating in a six-step mode, controller 226 switches chopper 223 on and off, varying the duty cycle to achieve desired voltages on second capacitor bank 224. The changing voltage on second capacitor bank 224 is then modulated by inverter section 225 to produce the six-step output waveform. When drive 220 is operating in a pulse width modulation mode, controller 226 keeps chopper 223 switched on. This allows first capacitor bank 222 to keep second capacitor bank 224 to essentially the same constant voltage. The constant on second capacitor bank 224 is then pulse width modulated by inverter section 225 to produce the desired output waveform.

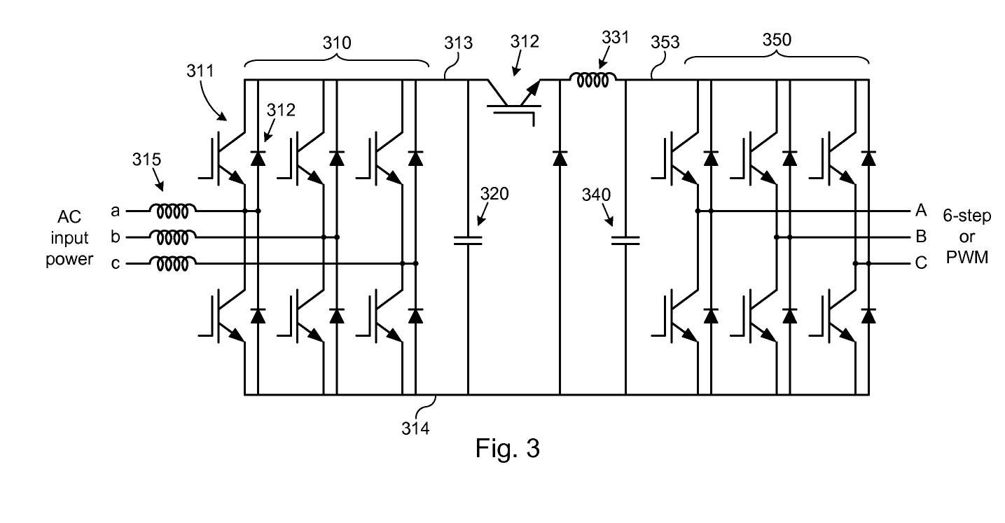

FIG. 3 is a diagram showing in greater detail the structure of a variable speed drive in accordance with one embodiment. Variable speed drive 300 has a converter section 310, a first capacitor bank 320, a chopper 330, a second capacitor bank 340, and an inverter section 350. Converter section 310 has three pairs of insulated gate bipolar transistors, or “IGBTs” (e.g., 311), each of which has a corresponding diode (e.g., 312). Each pair of IGBTs (with the corresponding diodes) is connected in series between upper rail 313 and lower rail 314 of converter 310. The junction of each pair of IGBTs is connected to one of the three phases (a-c) of an external power source (not shown) through a corresponding boost inductor (e.g., 315).

The gate of each IGBT is coupled to a controller (not shown), and is switched on and off by signals provided by the controller. The timing of the switching signals is designed to drive the voltage between rails 313 and 314 to a desired voltage. A first capacitor bank 320 is also connected between rails 313 and 314, and is charged to the desired voltage. The timing of the switching signals is designed to reduce the input harmonics of the variable speed drive. In one embodiment, the controller employs a third-harmonic injection methodology to control the switching of the IGBTs. Alternative methodologies may be implemented in other embodiments.

The inverter section 350 of variable speed drive 300 has a structure which is very similar to that of converter section 310. Inverter section 350 has three pairs of IGBTs, each of which has a corresponding diode. Each pair of IGBTs (with the corresponding diodes) is connected in series between an upper rail 353 and lower rail 314. Each pair of IGBTs in inverter section 350 is controlled to produce a separate phase (A-C) of a three-phase output waveform. The junction of each pair of IGBTs is therefore connected to a different one of the conductors of a three-phase output power cable (not shown) through an LC output filter.

A second capacitor bank 340 is connected between rails 353 and 314. Each output phase (A-C) is selectively connected to one or the other of rails 353 and 314 by appropriate switching of the IGBTs of inverter section 350. Thus, each of the output phases is switched between the voltage on rail 353 and the voltage on rail 314. The switching of the IGBTs is controlled by switching signals that are provided by the variable speed drive's controller (not shown). In one embodiment, the controller may be configured to operate alternately in either a pulse width modulation mode, or in a six-step mode. The switching signals provided by the controller to the IGBTs of inverter section 350 are timed according to the desired one of these modes. As the output waveform is produced, energy is drawn from second capacitor bank 340.

Rails 313 and 353 are coupled together through chopper 330 and inductor 331. In this embodiment, chopper 330 is simply a switch that can be alternately turned on and off. In this embodiment, chopper 330 is switched on and off by signals from the same controller that controls converter section 310 and inverter section 350. When chopper 330 is switched on, rail 313 is coupled to rail 353, and current can flow through the chopper to recharge second capacitor bank 340. When chopper 330 is switched off, rail 313 is disconnected from rail 353, preventing current from flowing through the chopper and allowing the voltage on second capacitor bank 340 to fall. Inductor 331 reduces the high-frequency components of the current flowing to second capacitor bank 340.

When drive 220 is operating in a six-step mode, controller 226 switches chopper 223 on and off, varying the duty cycle to achieve desired voltages on second capacitor bank 224. The changing voltage on second capacitor bank 224 is then modulated by inverter section 225 to produce the six-step output waveform. When drive 220 is operating in a pulse width modulation mode, controller 226 keeps chopper 223 switched on. This allows first capacitor bank 222 to keep second capacitor bank 224 to essentially the same constant voltage. The constant on second capacitor bank 224 is then pulse width modulated by inverter section 225 to produce the desired output waveform.

Variable speed drive 300 is configured to operate in either a pulse width modulation mode or a six-step mode. In the pulse width modulation mode, chopper 330 remains switched on so that the voltage on second capacitor bank 340 is substantially the same as the voltage on first capacitor bank 320. Inverter section 350 then generates a pulse width modulated output waveform, where the duty cycle of the output waveform is varied to approximate a sine wave having a desired voltage amplitude. In the six-step mode, chopper 330 is alternately switched on and off so that the voltage on second capacitor bank 340 remains at a desired level (which is variable). Inverter section 350 then generates a six-step output waveform using the voltage on second capacitor bank 340. The voltage on second capacitor bank 340 is varied to control the voltage amplitude of the output waveform.

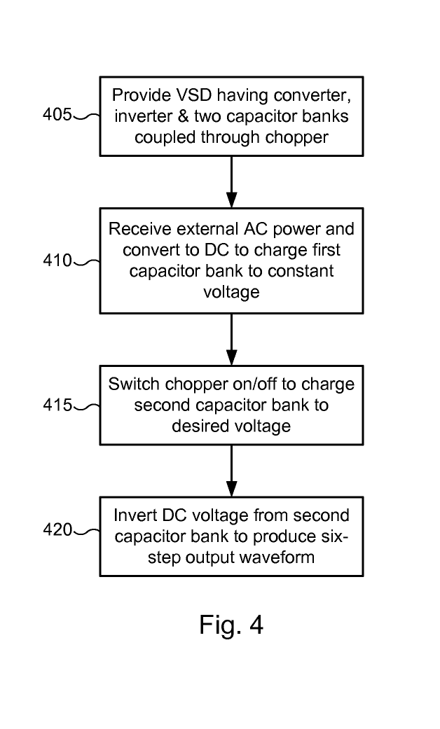

While the embodiments described above comprise hardware, it should be noted that alternative embodiments may include methods for generating output waveforms suitable for driving downhole equipment such as electric submersible pumps. One exemplary method is illustrated in the flow diagram of FIG. 4. In this embodiment, a variable speed drive is provided, where the variable speed drive has a converter section coupled to a first capacitor bank, a chopper coupled between the first capacitor bank and a second capacitor bank, and an inverter section coupled to the second capacitor bank (step 405). The converter section receives power from an external power source and controls the first capacitor bank to produce a substantially constant DC voltage on this capacitor bank (step 410). In a six-step mode, the chopper is switched on and off to charge the second capacitor bank to a desired voltage (step 415). In at least some instances, the chopper is operated with a duty cycle of less than 100% in order to charge the second capacitor bank to a voltage that is less than the voltage on the first capacitor bank. The inverter section then inverts the voltage on the second capacitor bank to produce a six-step output waveform (step 420). This output waveform is then supplied to the electric submersible pump to drive its motor.

In some embodiments, the variable speed drive may be operated alternately in the six-step mode, or in a pulse width modulation mode. In one alternative embodiment, the variable speed drive is initially operated in a pulse width modulation mode in which the chopper is switched on and the second capacitor bank is charged to the voltage on the first capacitor bank. When a pulse width modulation output form is produced, the output waveform is typically filtered to remove high frequency components from the waveform, thereby causing the waveform to more closely resemble a sine wave. In the event that the filters fail, the variable speed drive may be switched to the six-step mode. In the six-step mode, the chopper is switched on and off to charge the second capacitor bank to a voltage that may be less than the voltage on the first capacitor bank. The inverter section then produces a six-step waveform at the voltage of the second capacitor bank.

It should be noted that alternative embodiments of the system may include many variations of the features described above. For instance, although the chopper used in the foregoing embodiments is simply a switch, alternative embodiments may use another mechanism to control the amount of current that flows from the first capacitor bank to the second capacitor bank. Alternative embodiments may also employ types of switches other than IGBTs. Further, although the embodiments described above use a set of switches (IGBTs) to perform the functions of the converter and inverter sections, other structures may have other structures, as are known in the art. Still further, although the embodiments described above are implemented in connection with electric submersible pumps, alternative embodiments may be used in any system in which AC motor control is used. Still other variations to the foregoing embodiments may be apparent to those of skill in the art.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A variable speed drive comprising:
a converter section configured to convert received AC power to DC power;
a first capacitor bank coupled to the converter section, wherein the DC power produced by the converter section charges the first capacitor bank to a first voltage;
a second capacitor bank coupled through a chopper to the second capacitor bank, wherein the chopper selectively enables DC power from the first capacitor bank to charge the second capacitor bank; and
an inverter section coupled to the second capacitor bank and configured to invert DC power from the second capacitor bank, thereby producing an AC output waveform.

2. The variable speed drive of claim 1, wherein the AC output waveform comprises a six-step output waveform.

3. The variable speed drive of claim 1, wherein the chopper comprises a switch.

4. The variable speed drive of claim 3, wherein the chopper is configured to switch on and off with a duty cycle of less than 100%, and wherein the second capacitor bank is charged to a second voltage that is less than the first voltage.

5. The variable speed drive of claim 1, wherein the first voltage on the first capacitor bank is substantially constant.

6. The variable speed drive of claim 1, wherein the converter section is configured to be coupled to a three-phase external power source, wherein each phase of the three-phase external power source is selectively coupled to the first capacitor bank by a corresponding pair of switches.

7. The variable speed drive of claim 6, wherein the switches comprise IGBTs.

8. The variable speed drive of claim 6, wherein the converter section performs space vector modulation, thereby reducing input harmonics and providing a unity power factor in the variable speed drive.

9. The variable speed drive of claim 1, wherein the variable speed drive is configured to operate alternately in either a six-step mode or a pulse width modulation mode, wherein in the pulse width modulation mode, the chopper remains switched on and the second capacitor bank is maintained at substantially the first voltage; and wherein in the six-step mode, the chopper is alternately switched on and off, and the second capacitor bank is charged to a voltage that is determined at least in part by a duty cycle of the chopper.

10. An artificial lift system comprising:
an electric submersible pump; and
a variable speed drive coupled to the variable speed drive coupled to the electric submersible pump, wherein the variable speed drive includes
a converter section configured to convert received AC input power to DC power,
a first capacitor bank coupled to the converter section, wherein the DC power produced by the converter section charges the first capacitor bank to a first voltage,
a second capacitor bank coupled through a chopper to the second capacitor bank, wherein the chopper selectively enables DC power from the first capacitor bank to charge the second capacitor bank, and
an inverter section coupled to the second capacitor bank and configured to invert DC power from the second capacitor bank, thereby producing an AC output waveform.

11. The artificial lift system of claim 10, further comprising a set of boost inductors coupled to the converter section, wherein the converter section receives the AC input power through the boost inductors.

12. The artificial lift system of claim 10, wherein the AC output waveform comprises a six-step output waveform.

13. The artificial lift system of claim 10, wherein the chopper comprises a switch that is configured to switch on and off with a duty cycle of less than 100%, and wherein the second capacitor bank is charged to a second voltage that is less than the first voltage.

14. The artificial lift system of claim 10, wherein the first voltage on the first capacitor bank is substantially constant and is controlled by a controller coupled to the converter section, wherein the controller determines a switching algorithm used in the converter section.

15. The artificial lift system of claim 14, wherein the variable speed drive performs space vector modulation at the converter section, thereby reducing input harmonics and providing a unity power factor in the variable speed drive.

16. The artificial lift system of claim 10, wherein the variable speed drive performs space vector modulation at the converter section, thereby reducing input harmonics and providing a unity power factor in the variable speed drive.

17. The artificial lift system of claim 10, wherein the variable speed drive is configured to operate alternately in either a six-step mode or a pulse width modulation mode, wherein in the pulse width modulation mode, the chopper remains switched on and the second capacitor bank is maintained at substantially the first voltage; and wherein in the six-step mode, the chopper is alternately switched on and off, and the second capacitor bank is charged to a voltage that is determined at least in part by a duty cycle of the chopper.

18. A method for producing an output waveform suitable for driving downhole equipment such as an electric submersible pump, the method comprising:
providing a variable speed drive having a converter section coupled to a first capacitor bank, a chopper coupled between the first capacitor bank and a second capacitor bank, and an inverter section coupled to the second capacitor bank;
receiving AC power at the converter section from an external power source;
converting the AC power to DC power;
charging the first capacitor bank to a substantially constant first DC voltage;
in a six-step mode, switching the chopper alternately on and off, thereby charging the second capacitor bank to a desired voltage, wherein the chopper is operable with a duty cycle of less than 100%, and wherein the second capacitor bank is chargeable to a second voltage that is less than the first voltage; and
inverting the desired voltage on the second capacitor bank with the inverter section, thereby producing a six-step output waveform.

19. The method of claim 18, further comprising providing the output waveform to an electric submersible pump and thereby driving the electric submersible pump.

20. The method of claim 18, further comprising:
initially operating the variable speed drive in a pulse width modulation mode, wherein in the pulse width modulation mode, the chopper remains switched on, charging the second capacitor bank to the first DC voltage, and the inverter section inverts the voltage on the second capacitor bank, thereby producing a pulse width modulated output waveform; and
thereafter discontinuing the pulse width modulation mode and operating the variable speed drive in the six-step mode.
